(19) United States
(12) Patent Application Publication
(10) Pub. No.: US 2007/0174014 A1
(43) Pub. Date: Jul. 26, 2007

(54) Method for matching a model spectrum to a measured spectrum

(75) Inventor: Christian Halm, Jena (DE)

Correspondence Address: FOLEY AND LARDNER LLP;SUITE 500, 3000 K STREET NW, WASHINGTON, DC, 20007, US

(73) Assignee: VISTEC SEMICONDUCTOR SYSTEMS JENA GmbH

(21) Appl. No.: 11/655,985

(22) Filed: Jan. 22, 2007

(30) Foreign Application Priority Data
Jan. 25, 2006 (DE) 10 2006 003 472.4

(51) Int. Cl. G06F 19/00

(52) U.S. Cl. 702/85; 702/127

(57) ABSTRACT

With technical surfaces, in particular in semiconductor manufacture, it is a regular requirement to obtain the reflection coefficient of an inspected object (12). To better match the calculated model spectrum (16) to the obtained measured spectrum (18) with respect to damping when thick layers are measured, the measuring system (10) is measured with respect to its line spread I(λ). The measured line spread I(λ) is iteratively used for calculating the damping of the model spectrum (16), so that a damped model spectrum (20) is obtained.

### CROSS REFERENCE TO RELATED APPLICATIONS

This patent application claims priority of German Patent Application No. 10 2006 003 472.4, filed on Jan. 25, 2006, which application is incorporated herein by reference.

### FIELD OF THE INVENTION

The invention relates to a method for matching a model spectrum to a measured spectrum of an object, of a multi-layer system.

### BACKGROUND OF THE INVENTION

With technical surfaces, in particular in semiconductor manufacture, it is often necessary to determine the structural parameters of the surface. During the manufacturing process, applied line widths and line profiles of structured layers must be checked, for example, with respect to their dimensions and uniformity. The exact compliance with specifications for layer thicknesses is critical for the operativeness of the product. To check these manufacturing parameters the reflection on the sample is measured at different wavelengths. These measurements do not directly provide, however, the desired material data, such as the above-mentioned layer thickness. Rather, it is necessary to match the calculated values to measured values and to calculate a theoretical spectrum with the aid of a model using the theory of light scattering, and to compare it with the measurement. Subsequently, model parameters are changed until there is a best match between theory and measurement.

Reflection spectroscopy is a well-known and widely used method for inspecting layered systems, in particular of wafers, and for determining layer thicknesses and other optical parameters. To do this, a sample, preferably comprising a plurality of layers, is irradiated with light of a predetermined wavelength. If the layers are transparent in the range of this wavelength, light penetrates the layer and is partially reflected at the interfaces between two layers including the interface between the top layer and the ambient atmosphere. By overlapping the incident and reflected light beams, an interference results which affects the intensity of the reflected light. The ratio of the intensities of incident and reflected light thus determines the so-called absolute reflectance so that the two intensities have to be measured. If the wavelength is now continuously varied in a predetermined range, the reflection spectrum is obtained, which has maxima and minima as a function of the wavelength. These are caused by interference. The position of these extrema depends on the material properties of the sample inspected. The latter therefore determines the optical behavior. These optical parameters include the refractive index or the coefficient of absorption. Further, the layer thickness affects the position of the extrema in the reflection spectrum.

The basic formulae which are used to calculate the desired quantities from the comparison of the model with the measurement can be derived from Fresnel's diffraction theory.

These are described, for example in “Spectroscopic Ellipsometry and Reflectometry—A users Guide” by H. G. Tompkins and W. A. McGahan.

In this context, reflection refers to the ratio of the outgoing intensity and the incoming intensity. It is calculated separately for the two polarization planes, “s” referring to vertical and “p” referring to parallel. The intensity in turn is proportional to the square of the amplitude of the light wave function.

Equation (1) describes the wave function on a simple surface, i.e. on an interface between two media having different, complex, where applicable, dispersions.

$${r}_{12}^{p} = \frac{{\tilde{N}}_{2} \cdot cos {φ}_{1} - {\tilde{N}}_{1} \cdot cos {φ}_{2}}{{\tilde{N}}_{2} \cdot cos {φ}_{1} + {\tilde{N}}_{1} \cdot cos {φ}_{2}} and \\ {r}_{12}^{s} = \frac{{\tilde{N}}_{1} \cdot cos {φ}_{1} - {\tilde{N}}_{2} \cdot cos {φ}_{2}}{{\tilde{N}}_{1} \cdot cos {φ}_{1} + {\tilde{N}}_{2} \cdot cos {φ}_{2}} \qquad ( 1 )$$

If there is a further medium, this is referred to as a simple layer or a film having the thickness d. For this model, too, the reflection R can be indicated using a closed formula for each of the polarization planes s and p (Eq. 2).

$${R}^{p} = \frac{{r}_{12}^{p} + {r}_{23}^{p} \cdot exp ( - j 2 β )}{1 + {r}_{12}^{p} \cdot {r}_{23}^{p} \cdot exp ( - j 2 β )} and \\ {R}^{s} = \frac{{r}_{12}^{p} + {r}_{23}^{p} \cdot exp ( - j 2 β )}{1 + {r}_{12}^{s} \cdot {r}_{23}^{s} \cdot exp ( - j 2 β )} \qquad ( 2 )$$

It is composed of the Fresnel coefficient (equation 1) of the two interfacing layers and a complex e-function, wherein the indices 1 and 2 must be replaced by 2 and 3 for the lower interfacing layer.

In

$$β = 2 π ( \frac{d}{λ} ) {\tilde{N}}_{2} cos {φ}_{2} \qquad ( 3 )$$

the e-function has the complex optical thickness d·Ñ as an argument and, with its periodicity, it describes the oscillating behavior of the reflection, which results from interferences within the film.

Ñ₂=n₂−j·k₂ (4)

The values for the dispersion Ñ is also complex, as is that of the cosine function cos Φ₂.

The measurable reflection on the surface is calculated separately for vertically and horizontally polarized light from the values of the wave functions according to the equations (5).

$$\begin{matrix}{ℜ}^{p} \text{:} = {\vert {R}^{p} \vert}^{2} = {( \sqrt{{( {R}_{x}^{p} )}^{2} + {( {R}_{y}^{p} )}^{2}} )}^{2} \\ = {( {R}_{x}^{p} )}^{2} + {( {R}_{y}^{p} )}^{2}\end{matrix} \\ and \\ {ℜ}^{s} \text{:} = {\vert {R}^{s} \vert}^{2} = {( {R}_{x}^{s} )}^{2} + {( {R}_{y}^{s} )}^{2} \qquad ( 5 )$$

With an equal distribution of the polarizations in the incident light, the whole of the unpolarized reflection is given by the arithmetic mean according to equation (6).

$$ℜ \text{:} = \frac{{ℜ}^{p} + {ℜ}^{S}}{2} \qquad ( 6 )$$

Snell's law also applies for the complex sine function

Ñᵢ₊₁·sin φᵢ₊₁=Ñ₁·sin φᵢ, (7)

so that for the incident angle of the i-th layer

$$\begin{matrix}sin {φ}_{i + 1} = sin {φ}_{i} \cdot \frac{{\tilde{N}}_{i}}{{\tilde{N}}_{i + 1}} \\ = sin {φ}_{i - 1} \cdot \frac{{\tilde{N}}_{i - 1}}{{\tilde{N}}_{i}} \cdot \frac{{\tilde{N}}_{i}}{{\tilde{N}}_{i + 1}} \\ = sin {φ}_{0} \cdot \frac{{\tilde{N}}_{0}}{{\tilde{N}}_{i + 1}}\end{matrix} \qquad ( 8 )$$

applies. The medium surrounding the layered system is usually air. With a real Φ₀, sin Φ₀ is also real, since for Φ₀, only n₀ is taken into account, and not k₀. Φ₁ can take on a complex value, however, when Ñ₀ or Ñ₁ are complex. With sin Φ₀ known, sin Φᵢ₊₁ can be calculated for all layers. cos Φᵢ, which is required for calculating the optical parameters, with (sin Φᵢ)²+(cos Φᵢ)²=1, results in:

cos Φᵢ=\sqrt{1−(sin Φᵢ)²} (9)

The matching of a theoretically calculated curve to a measured curve with the aid of a model of variable parameters will be referred to as a fit in the following. To do this, the model parameters are varied in such a way that there is a best match between the theoretical curve and the measured curve.

The standard method for a fit is the so-called gradient method, since it enables the exact result to be found quickly, wherein the procedure to be followed is described, for example, in DE 102 27 376 A1. The calculation is carried out at intermediate points, wherein a number of the intermediate points in the model spectrum are chosen to be as good as possible, corresponding to the number of intermediate points in the measured spectrum.

If the reflection spectrum of a thick layer is calculated with the aid of a model based on the above mentioned equations, the result is a strongly oscillating model spectrum. If the reflection spectrum of a thick layer is recorded with a spectral photometer, however, the resulting measured spectrum is damped when compared to the model spectrum. The reason for this, inter alia, is that in the use of light with high intensities and using objectives having high magnifications, the stability of the illumination and its insufficient adjustment means lead to a bad result with high resolutions. In DE 101 33 992 A1 it is therefore suggested that an illumination means be used having a light source and an illumination optics which allows for automatic post-adjustment.

Imaging errors in the optical channel, which are caused, for example, by the entrance slit or the imaging grid, before the light is incident on the detector, cannot be compensated for, however. These cause a damping of the measured curve in the measured spectrum, which is the stronger, the thicker the layers of the measured object. For example, the strongly oscillating spectrum is already markedly damped with a spectral photometer when recording the reflection of a layer having a thickness of 5 μm. When layers having an even greater thickness are measured, the visible damping is further increased, until the oscillation of the spectrum completely disappears between 25 μm and 50 μm. For calculating the associated model spectrum for layer thicknesses of these dimensions, usually an FFT technique is used, since it is quite useful for determining the layer thickness. The damping effect described is, however, hardly reflected in this method, so that the determination of the layer thickness is hardly affected by the damping. The user of the method obtains two very diverse looking spectra for the measured spectrum and the model spectrum, even though the model spectrum is the best fit of the measured spectrum. Usually, however, the user evaluates the quality and the success of an analysis by visual means and interprets these differences as a defect or failure of the algorithms, insofar as he is not familiar with the technical reasons for the damping, which is usually not the case. The mean square error (MSE), a second quality criterion for the analysis, is very large and seems to signal an error or a bad result.

### SUMMARY OF THE INVENTION

It is therefore an object of the present invention to match a model spectrum of an object, in particular a multi-layer system, with thick layers, to a systematically damped measured spectrum.

According to the present invention, this object is achieved by a method for matching a model spectrum to a measured spectrum. According to the present invention, a method for matching a model spectrum to a measured spectrum of an object, in particular a multi-layer system, is suggested. Herein, a measured spectrum of an object is first detected using a measuring system, in particular a spectrometer. An associated model spectrum is calculated with the aid of a suitable model, wherein the calculation is carried out with a plurality of wavelengths and a number of intermediate points. To match the model spectrum to the measured spectrum, first the measuring system is measured with respect to its line spread. To do this, monochromatic light, in particular, can be radiated into the measuring system. The line spread introduced by the measuring system is then measured on the detector, so that an intensity development of the widened line is obtained as a function of the wavelength. To match the model spectrum to the measured spectrum, which is damped with the measurement of thick layers, in particular, the measured line spread is iteratively used for the calculation of the damping of the model spectrum so that matching can be carried out in this manner.

According to the invention, the matching is iteratively carried out in several steps. A local mean value is preferably calculated for all intermediate points of the spectrum, wherein the calculation can be carried out, for example, by dividing the sum of the values of a number of next neighboring intermediate points, weighted with a normalized flat Gaussian curve, by the sum of the weights used with the Gaussian curve for all intermediate points. Each intermediate point has therefore a local mean value associated with it, which is then varied by a damping in a plurality of iterative steps.

The iterative process then begins by setting one weighting factor LS for diffraction and one weighting factor LD for the light attenuation to 1. For a first damped model spectrum, the damping of the amplitude is calculated by multiplying the model spectrum with a current value of LS and by compensating the lost height of the amplitude by adding the local mean value, multiplied by the current value of LD, wherein LS and LD are initially 1, basically however always equal to or smaller than 1 and greater than 0. The thus obtained damped model spectrum is then convoluted with the initially measured line spread. If the line spread is already known and stored for the system used, it can also be read from the present memory. After the convoluting step, the values for LS and LD are newly set and the iterative process for determining a new damped model spectrum is repeated until the difference between the old and new values for LS or LD normalized to the new values for LS or LD, respectively, is smaller than a predetermined percentage, in particular smaller than 1%.

To set the new value for LD, according to a preferred embodiment of the invention, first the ratio between the mean value of all intermediate points of the measured spectrum and the mean value of all intermediate points of the model spectrum is formed and multiplied with the old value for LD. To determine the new value for LS, first the ratio between the value of the mean change of two neighboring intermediate points of the measured spectrum and the value of the mean change of two neighboring intermediate points of the model spectrum is formed and multiplied with the old value for LS.

The calculation of the new damped model spectrum 20 is then iteratively continued until the percentage change from the old to the new values for LS and LD falls short of a predetermined value, such as about 1%.

### BRIEF DESCRIPTION OF THE DRAWINGS

Further advantages and advantageous embodiments of the invention are the subject matter of the subsequent figures and their descriptions, in which an illustration to scale has been omitted for clarity. In the figures:

FIG. 1 shows the schematic structure of the measuring system according to the present invention; and

FIG. 2 schematically shows the sequence of the method according to the present invention.

### DETAILED DESCRIPTION OF THE INVENTION

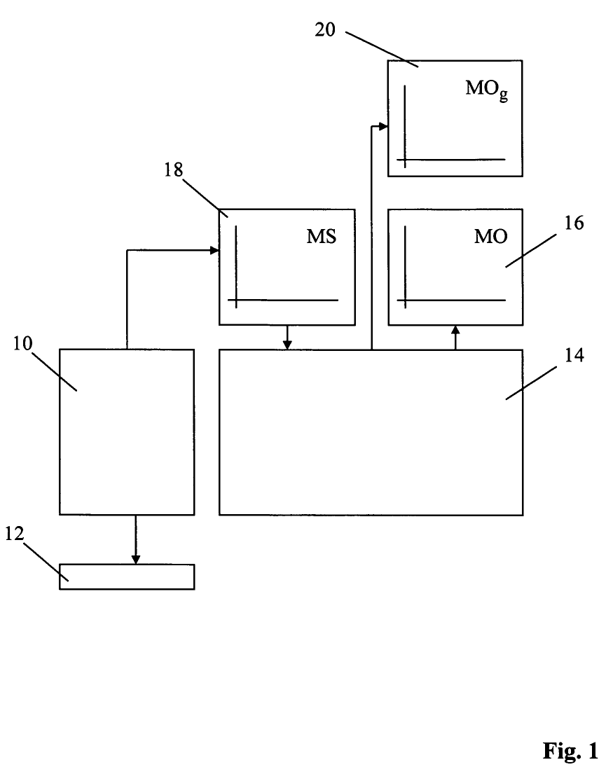

FIG. 1 schematically shows the structure of the measuring system according to the present invention with the spectra obtained thereby. A measuring or inspection system 10, such as a spectral photometer, is provided with the aid of which a measured spectrum 18 can be recorded from an object 12. The measuring or inspection system can be structured such as described, for example, in DE 101 33 992. Object 12 can be a multilayer system, in particular. The data of the measured spectrum 18 are also made available to a computer unit 14, which can also be integrated into measuring system 10. A model spectrum 16 associated with object 12 and corresponding to measured spectrum 18 is calculated with the aid of a suitable model by computer unit 14.

In the calculation of model spectra of thick layers, preferably an FFT technique is used, in which any damping, if present, is hardly effective. The determination of the layer thickness is therefore only little influenced by the damping, so that the model spectrum of a thick layer of object 12 oscillates strongly. Measured spectrum 18 of a thick layer recorded with the aid of spectral photometer 10, however, is damped in comparison. The user of the spectral photometer therefore obtains a measured spectrum 18 and a model spectrum 16 which look very different, even though calculated model spectrum 16 is the best fit of measured spectrum 18.

To avoid this effect, a method is stored in computer unit 14, with the aid of which a damped model spectrum 20 can be calculated from model spectrum 16, wherein a systematic damping of the measured spectrum is taken into account without affecting the quality of the parameters calculated with the model spectrum. When a thick layer is detected, this method can be started additionally by the user, such as by selection, or automatically by the system, when a thick layer is detected.

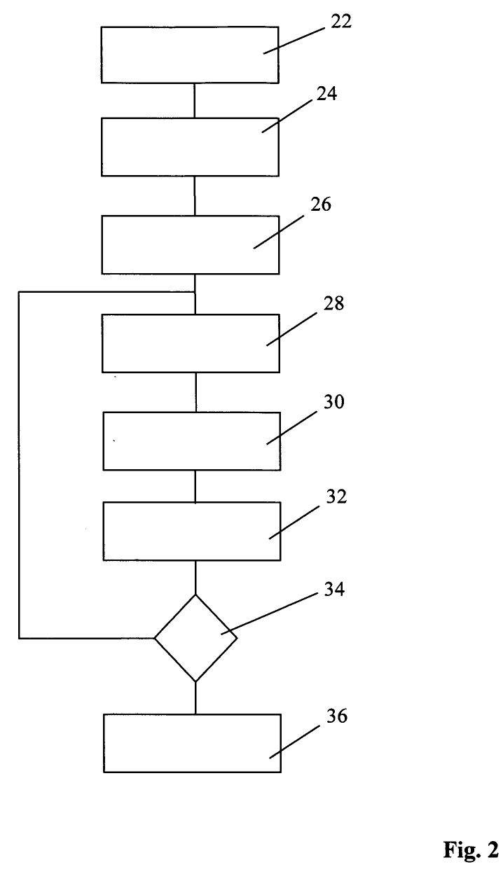

The basic sequence of the method, which can be stored in computer unit 14, for example, as a software, is schematically illustrated in FIG. 2. Before the desired match can be carried out the present measuring or inspection system 10 is measured in a measuring step 22. For this purpose, monochromatic light or the light of one or more sharp lines, such as of a sodium or mercury vapor lamp is used as a light source and the line spread caused by the system is measured by the detector. The result is an intensity curve I(λ) of the spread line versus the wavelength λ, which can have the form of a Gaussian curve, for example. This intensity curve can also be stored in a storage area of computer unit 14 as a result of measuring the system and, being system-specific, can be reused for damping other model spectra.

For damping the current model spectrum 16, the local mean values R̅ᵢ̅ are calculated for all intermediate points of model spectrum 16 in an averaging step 24. To do this, it can be provided, for example, that for all intermediate points from the model spectrum, the sum of the values of a number of next neighboring intermediate points, weighted with a normalized flat Gaussian curve is used. This value is divided by the sum of the used weights of the Gaussian curve, so that:

$${\overline{R}}_{i} = \frac{{\sum }_{j = - n}^{+ n} exp ( - \frac{1}{2} {( \frac{j \cdot Δ λ}{4} )}^{2} ) \cdot {R}_{i + j}}{{\sum }_{j = - n}^{+ n} exp ( - \frac{1}{2} {( \frac{j \cdot Δ λ}{4} )}^{2} )} , \qquad ( 10 )$$

Wherein σ=4 and

i is the index of the intermediate point,

### Rᵢ₊ⱼ is the value of the spectrum at intermediate point (i+j), if any,

Δλ is the size of the interval, i.e. the distance between intermediate points,
n is the number of neighboring intermediate points involved, and

### R̅ᵢ̅ is the local mean value of the spectrum at intermediate point i.

If at the edge of the model spectrum not all desired neighboring intermediate points are available, only those available are summed and divided by the corresponding sum of Gaussian weights. The result is a local mean value R̅ᵢ̅ at each intermediate point. To prepare the iterative process for damping model spectrum 16, a weighting factor LS for light diffraction and a weighting factor LD for light attenuation is set to 1 at the end of step 24.

For the further procedure, a mean value M for the spectrum and A for the value of the mean change of the value between neighboring intermediate points is defined.

$$M \text{:} = \frac{1}{N} {\sum }_{i = 1}^{N} {R}_{i} and A \text{:} = \frac{1}{N - 1} {\sum }_{i = 1}^{N - 1} \vert {R}_{i + 1} - {R}_{i} \vert \qquad ( 11 )$$

The corresponding values for the measured spectrum M_{measured spectrum} and A_{measured spectrum} are then calculated from the values for the intermediate points of measured spectrum 18 in step 26.

In damping step 28, the amplitude of the oscillation of model spectrum 16 is damped without the spectrum substantially losing in height. To do this, the spectrum is multiplied with value LS which is 1 at the first iteration and then smaller than 1, but always larger than 0. The lost height is then compensated for by adding a corresponding portion of the previously calculated local mean value R̅ᵢ̅. To simulate a light loss, this is not completely carried out, however, but the compensation is reduced by the value of factor LD. LD is also equal to 1 in the first iteration, then smaller than 1, but always larger than 0. Put as an equation, the damped value for Rᵢ, for intermediate point i, is therefore:

Rᵢ=LS·Rᵢ+LD·(1−LS)· R̅ᵢ. (12)

In step 30, the damped model spectrum 20 is convoluted with the measured line spread I(λ), which now provides a damped model spectrum 20 which takes the system damping into account.

To determine whether or not a further iteration step is necessary for matching the damped model spectrum 20 to the measured spectrum 18, values M_{model spectrum} and A_{model spectrum} for model spectrum 16 are now calculated using equations (11) with the current values for LS and LD in step 32. Subsequent to this, the values for LS and LD are newly calculated. They are obtained from the old values for LS and LD, multiplied with the ratios for M and A from the measured spectrum and the model spectrum, which yields:

$${LD}_{neu} = {LD}_{alt} \cdot \frac{{M}_{measured spectrum}}{{M}_{model spectrum}} and \\ {LS}_{neu} = {LS}_{alt} \cdot \frac{{A}_{measured spectrum}}{{A}_{model spectrum}} \qquad ( 13 )$$

In step 34, it must be checked whether changes in the values LD and LS are sufficiently small with respect to the previous iteration so that the iteration can be interrupted. To do this, differences Diff1 and Diff2 are formed:

$$Diff 1 = \vert \frac{{LD}_{old} - {LD}_{new}}{{LD}_{new}} \vert and$$

$$Diff 2 = \vert \frac{{LS}_{old} - {LS}_{new}}{{LS}_{new}} \vert$$

and it is checked whether or not Diff1 and Diff2 fall short of a predetermined percentage, such as about 1%. If this is the case, the procedure is ended with step 36 and the damped model spectrum sought after has been found.

If not, the procedure is continued with the new values of LS and LD in step 28 and the iterative loop continued until the damped model spectrum 20 sought after has been found.

What is clamed is:

1. A method for matching a model spectrum to a measured spectrum of an object, of a multi-layer system, comprises the steps of:
detecting the measured spectrum with a measuring system,
calculating an associated model spectrum with a plurality of wavelengths and a number of intermediate points,
measuring the measuring system in view of its line spread I(λ), and
iteratively using the measured line spread I(λ) for calculating the damping of the model spectrum.

2. The method according to claim 1, wherein local mean values R̅ᵢ̅ are calculated for the intermediate points of the model spectrum.

3. The method according to claim 2, wherein the local mean values R̅ᵢ̅ are calculated by dividing, for all intermediate points, the sum of the values of a number of next neighboring intermediate points, weighted with a normalized flat Gaussian curve, by the sum of the weights used for the Gaussian curve.

4. The method according to claim 1, wherein a damped model spectrum is calculated by damping the amplitude by multiplying the model spectrum with a value LS and the height of the amplitude thus lost is compensated for by adding the local mean value of R̅ᵢ̅, multiplied with a factor LD, wherein the value LS and the factor LD are equal to or smaller than one and greater than zero.

5. The method according to claim 4, wherein the damped model spectrum is convoluted with the measured line spread I(λ).

6. The method according to claim 5, wherein initial values for the values LS and the factor LD are set to 1, and then newly determined after each convolution of the damped model spectrum with the measured line spread, and the calculation of a newly damped model spectrum is carried out until the difference between the old and new values LS and the new factor LD normalized to the new value LS and the new factor LD is smaller than a predetermined percentage.

7. The method according to claim 6, wherein for determining each new value LS from the measured spectrum and the damped model spectrum, the value of the mean change A of the value of two respective neighboring intermediate points is calculated as:
$$A \text{:} = \frac{1}{N - 1} {\sum }_{i = 1}^{N - 1} \vert {R}_{i + 1} - {R}_{i} \vert .$$

8. The method according to claim 7, wherein the new value LS is calculated from the ratio of the values A of the measured spectrum relative to the damped model spectrum with the equation:
$$LS = LS \cdot \frac{{A}_{measured spectrum}}{{A}_{model spectrum}} .$$

9. The method according to claim 6, wherein for determining the new factor LD from the measured spectrum (18) and the damped model spectrum, the mean value M of the averaged change of the value of two respective neighboring intermediate points is calculated as:
$$M \text{:} = \frac{1}{N} {\sum }_{i = 1}^{N} {R}_{i} .$$

10. The method according to claim 9, wherein the new factor LD is calculated from the ratio of the values M of the measured spectrum relative to the damped model spectrum with the equation:
$$LD = LD \cdot \frac{{M}_{measured spectrum}}{{M}_{model spectrum}}$$
